(19) United States
(12) Patent Application Publication
(10) Pub. No.: US 2010/0248078 A1
(43) Pub. Date: Sep. 30, 2010

(54) Aqueous lithium ion cell possessing high specific energy and electrolyte with high, stable cell voltage

(76) Inventor: Kirby W. Beard, Norristown, PA (US)

Correspondence Address: Kirby W. Beard, 7024 Windswept LN, Norristown, PA, 19403, US

(21) Appl. No.: 12/383,889

(22) Filed: Mar. 31, 2009

(51) Int. Cl. H01M 8/00; H01M 6/04; H01G 9/00

(52) U.S. Cl. 429/501; 429/188; 361/503

(57) ABSTRACT

An electrochemical device is proposed that uses a novel electrolyte system technology, based on the use of conventional electrodes with high specific capacity selected to provide operating cell potentials within a range of approximately between 1.2 and 2.4 volts along with the use of an unconventional electrolyte solution. Specifically, his novel electrolyte system is based on the use of an aqueous electrolyte solution that has a window of voltage stability above the range of conventional aqueous electrolytes. Any of a variety of acid, neutral or basic aqueous solutions or gels with or without any of a variety of co-solvents, inorganic or organic salts or ionic liquids may be employed provided the conductivity and stability of the electrolytes are compatible with the selected electrochemical couples so as to provide high cell capacity, high rate capability and long term stability.

### CROSS REFERENCE TO RELATED APPLICATIONS

This application claims priority benefit of Provisional Application No. 61/068,706 (United States Patent and Trademark Office, Mar. 27, 2007).

### BACKGROUND OF THE INVENTION

Conventional lithium ion electrochemical cells employ electrodes that are capable of absorbing and/or desorbing lithium ions, often reversibly. To provide for maximum cell energy the electrode materials are selected for both high specific capacity (mAh/g, mAh/cc) and high cell voltage couples. The cells almost always exceed 2 volt potential and often 3 or even 4 volts. Such high cell voltages will decompose many electrolyte solutions due to electrolysis. The use of specialized organic liquids, along with specialized lithium salts with adequate dissociation capabilities in such solvents, are required. A number of companies (starting with Sony and Bellcore/Telcordia in the early 1990's) have commercialized this type of lithium ion cell technology over the last decade and lithium ion cells now serve as the principle power source for most all cell phones, notebook computers and other such devices with electric vehicles as a new potential large market application.

These cells often use organic esters, ethers, carbonates and similar liquids and active electrode materials such as LiNiCoO2 and carbon/graphite that provide specific capacity of >150 mAh/g. The cost of the materials is often quite expensive, and safety problems with all of these components have been well documented. Cells have often caught fire or exploded not only during manufacture but also during use. The cathodes and anodes both exhibit uncontrolled thermal events when abused. The organic liquids are almost always flammable ones. As a result companies have commercialized a variety of safer electrode compounds. Altairnano Technologies is selling a lithium titanate to replace carbon anodes and Phostech Lithium and A123 Systems are both claiming the invention of a lithium iron phosphate material as a safer cathode active material. Progress on improving the safety of the electrolytes has been less impressive. Replacement of the standard LiPF6 salts used in most lithium ion cells has been a focus, but the development of less reactive or inflammable organic solvents has not been as productive. Gel polymers, vinyl carbonates, shuttle mechanisms (Air Product's lithium fluoroborates) and numerous other compounds or additives have been developed but with little universal acceptance.

One interesting alternative approach to improving safety of lithium ion cells, first known to have been presented in U.S. Pat. No. 5,284,721 (filed by the author of the present invention, Kirby W. Beard, on Aug. 1, 1990), suggested the idea of using an aqueous electrolyte solution. This patent first proposed the use of lithium titanates as an active anode material and recommended coupling such anodes to various high voltage cathodes materials such as LiCoO2. The main claims suggested the use of conventional organic liquids/lithium salt electrolytes, but sub-claims also allowed for using aqueous electrolyte solutions in both lithium ion cells and lithium air or water cells. Item VIII. in Tables 1 and 2 in this patent presented the idea of an aqueous cell with >2.5 volts and ˜200 mAh/g specific electrode capacity. While theoretically possible for use as a primary or reserve cell, the high voltage levels required for charging these cells would not be achieved due to decomposition (electrolysis) of the water during recharge or even during open circuit stand.

Others have subsequently proposed the use of lithium ion cells with aqueous electrolytes configured in different manners. U.S. Pat. No. 7,282,295 (Visco, PolyPlus) has proposed the use of protective layers on the lithium anodes to block out any water from direct contact to the anode. While allowing a variety of electrode materials and aqueous electrolytes to be used, the technology is hampered by the use of the protective layer, which reduces ionic conductivity and total cell energy. Others (U.S. Pat. No. 6,645,667, Iwamoto, Matsushita) have mentioned the use of electrochemical couples but with reduced cell potentials more compatible with the voltage limits of aqueous solutions. The patent lists Japanese Patent H09-508490 and an undocumented publication (Jun. 9, 1999) as examples using water-based electrolytes. The patent correctly states that the stability of these systems is limited to 1.2 volts. In essence, then, any electrochemical couple that requires charging to above 1.2 volts will simply electrolyze the water and fail to properly recharge the cell to full capacity. A pre-charged or primary lithium ion cell with initial, open circuit voltage above 1.2 volts would also corrode and degrade when activated with any type of normal aqueous electrolyte system, and of course any lithium metal anode cell could not be exposed to water without severe hazardous reactions. While certain electrode materials could indeed function in such cells (i.e., lithium titanate anodes with V6O13 cathodes) the cell voltage and in turn the cell energy would be too depressed to provide a very practical cell design

In summary, in order to utilize safe, highly conductive and low cost aqueous electrolyte solutions, a lithium ion cell with electrodes of relatively high specific capacity (i.e., 150-200 mAh/g or higher) and with an aqueous electrolyte of moderately high voltage stability (i.e., >1.5 volts, or preferably >2.0 volts or even more preferably >2.5 volts) is required. Other enhancements to the aqueous electrolyte cell design that could enable improved high rate charging at such higher voltages (i.e., oxygen recombination as first patented by Gates Energy Products over 30 years ago) would also be novel and of worthwhile benefit.

### DESCRIPTION OF THE RELATED ART

The key aspect of the present invention involves the use of currently known lithium ion electrode materials, but in a unique, novel aqueous electrolyte solution capable of conducting lithium ions at high current density and of functioning at high voltage levels. Specifically, most common aqueous electrolytes decompose when charged to more than 1.2 volts. No known lithium salts, shuttle reagents, solvent modifiers or various other such additives have previously been shown to vastly improve the charging limits of traditional aqueous electrolytes. However, a newly identified approach offers promise to allow improved charging of aqueous electrolytes to enable the practical design of aqueous lithium ion cells. Specifically, one can observe that in lead acid cells the use of sulfuric acid solutions as the electrolyte is known to provide increased voltage stability. Lead acid cells are routinely charged to >2.25 volts with only minimal electrolysis of the water. Any gassing from the cell is minimal and controllable, allowing long calendar life, long cycle life and minimal self discharge. The water lost during charge to out-gassing can be periodically replaced as is commonly done with lead acid cells that are “watered”, but the use of “recombinant” technology is also a novel idea that could be used for any proposed aqueous lithium ion cell technologies. The use of “recombination” of the oxygen to reform into water has been used effectively as an overcharge mechanism for both nickel cadmium and lead acid cells for decades. The electrolysis of water is minimized by allowing the oxygen generated at one electrode to diffuse back to the other electrode and recombine to form water. This same basic concept can be used for the present invention.

In general, the present invention proposes to use an aqueous electrolyte solution with increased resistance to electrolysis of water as a novel electrolyte solution for a new type of higher voltage aqueous lithium ion cell. No protective coatings are required for the anodes and the capacity is not limited to using active materials with either low specific capacity or low voltage couples. In fact, two of the currently most promising lithium ion electrode materials (lithium titanate anode and lithium iron phosphate cathode) would make ideal candidates for the present invention. Both materials have specific capacity >150 mAh/g and when coupled will produce cells with a charge/discharge voltage range of about 2.4 to 1.2 volt. The use of a LiCoO₂ and Li₄Ti₅O₁₂ electrochemical couple at 2.3 volts nominal is potentially conceivable for this new aqueous electrolyte technology, but any other current or future active materials could also be used as long as a stable and compatible aqueous electrolyte solution was employed, too.

The main benefits from using an aqueous electrolyte, rather than a organic liquid or other exotic liquids, gels, solid state conductors and such, is that the cell assembly can be done easily and inexpensively without the need for dry rooms, glove boxes or other elaborate environmental controls or manufacturing equipment. Aqueous electrolytes would be far less expensive than organic liquids, too, as the conventional organic solvents require complex and difficult chemical synthesis. The most obvious benefit, though, is that aqueous systems are safe and non-reactive. Whether the cells are structurally damaged, overcharged or otherwise abused, no fire, explosions or other hazardous events are likely in normal use. It would only be necessary to prevent excessive hydrogen generation and accumulation during overcharge just as with lead acid cells.

The use of a sulfuric acid electrolyte solution with any of a variety of lithium salts (LiCl, LiPF6, LiBF4, lithium triflate, LiBETI, LiClO4, etc.), ionic liquids, conductive gel polymers, etc. are all potential candidates if proven stable with the electrolytes and electrode materials within the required voltage window. However, any other aqueous solution with increased resistance to electrolysis could be employed as well in these cells. Other acids (hydrochloric, nitric, acetic, etc.) as well as bases (ammonia, sodium hydroxide, etc.) and neutral aqueous solutions with special additives could be employed. For instance, Air Product's lithium fluoroborate compounds could serve to allow increased charge in an aqueous lithium salt solution. The aforementioned examples are not intended to be fully inclusive or limiting in any way. As long as the electrolyte is stable and/or able to handle higher voltage charging (i.e., above 1.2 volts) and a degree of over-charge without degradation of the cell components, any combination of electrodes, solvents, salts and additives is envisioned as new and novel art consistent with the present invention. The basic requirement is that the cell potential in this new invention must be both higher than prior art examples (>1.2 volts) and stable. No upper voltage level is imposed in this invention, but a practical limitation of 2.5 to 3 volts is likely before overcharge problems occurred.

These new cell designs will likely have practical cell energy levels of >50 wh/kg and >100 wh/l with rate capabilities of as much as 3,000 w/kg (per CEA-Alorisation). The cycle life of both the lithium titanates and the lithium iron phosphates has been proven at well over 5000-10,000 full depth of discharge cycles. However, with expected improvements in the overall cell design, cell energy and power of 100 wh/kg and 10,000 w/kg, respectively, are not out of the question. The applications for this new technology will include electric and hybrid electric vehicles, telecommunication and UPS back-up power, power tools, utility load leveling, portable electronics, etc. among others. This electrolyte technology could also be employed in capacitors, fuel cells or any other electrochemical devices. The use of lithium titanate with a nickel, carbon or similar counter electrode could provide a novel type of ultra-capacitor (eg., U.S. Pat. No. 6,824,923 for an ultra-capacitor, but replacing the conventional organic non-aqueous electrolyte with a special aqueous electrolyte solution consistent with the present invention). The type of separators used could include microporous polymers but any woven or nonwoven web, ceramic, gel or other technology could be implemented as well in the present invention.

Various important benefits derive from having an aqueous electrolyte that is significantly higher in ionic conductivity compared to conventional non-aqueous lithium battery electrolytes. Most non-aqueous electrolytes have about 0.001 to 0.01 S/cm conductivity while aqueous electrolytes range from 0.1 to 0.5 S/cm. This order of magnitude improvement not only provides for better rate capability but also opens the door for a complete redesign of the cell. Electrodes can be increased proportionately in thickness and/or compaction density to yield cells with more active materials and less volume devoted to inert components such as current collectors, separators and excess electrolyte. Such cells could conceivably have electrodes with 10 times thicker/less porous coatings giving cells with nearly 80% active material volume vs. less than 50-60% with conventional electrode stack designs. Energy density would be improved proportionately with rate capability largely unaffected due to the intrinsic high aqueous electrolyte conductivity.

The binders for the electrode particles can employ any of the standard polymers, such as Teflon, PVDF, PAN, SBR, etc., but especially PEO which is swellable in aqueous solutions and can form a gel polymer. These electrodes can also then be laminated as typical to the original Bellcore (PVDF-HFP) and Valence (PEO) technologies or other such newer technologies. The separators. can be constructed with any of the common polymers, but ones that will absorb and swell with aqueous solutions and allow gas permeation and recombination of the oxygen gas generated on charge will be especially useful.

In addition these new types of aqueous lithium ion cells will likely have some unique features related to oxygen recombination. Standard sealed lead acid cells must develop enough internal pressure during recharge to force the oxygen through the thick fiberglass mat separator to effect regeneration of water from oxygen at the opposite electrode. The original Gates Energy Product cells operated at nearly 50 psig of internal pressure in order to enhance oxygen recombination. Later sealed, recombinant lead acid cell designs were able to reduce this pressure level to only about 3-5 psig, but specialized battery cases and vent systems were still needed to properly control gas pressure release and recombination. Alternatively, the new proposed aqueous lithium ion cell designs will employ separators that are typically only about 25 micron thick, compared to lead acid battery separator which can be 10 to 100 times thicker. The thinner separators employed in the specified novel lithium cells will allow for a more direct path for gas diffusion and immediate water regeneration. This feature will not only improve the overcharge mechanism (i.e., making oxygen recombination more efficient) but will reduce the need for high internal cell pressures. In fact by keeping the electrodes. in narrowly spaced, close contact, such as occurs in laminated Bellcore type cell designs, the need for any pressurization of the cell compartment is obviated. The oxygen gas can be caused to be channeled direct from the first electrode to the second electrode without any loss to the surroundings.

A number of novel mechanisms can be used to enhance the oxygen recombination, also. For example by including non-wetting particles in the separator films (i.e., Teflon) in a fine dispersion over the surface and throughout the entire thickness, the oxygen could directly flow between the separators through the dry areas. Further, by using a “starved” electrolyte system (i.e., one that is similar to the absorbed glass mats used in the original Gates lead acid sealed cells), open voids in the separator will help to channel the oxygen flow. Simply by using ultrathin separators, unlike thicker lead acid battery separators, the need for actual gas diffusion pathways is minimized since any gas bubbles formed at one electrode are likely to quickly grow to a size (eg., 25 micron) that extends through entire separator and allows direct recombination at the opposite electrode.

### SUMMARY OF THE INVENTION

The present invention proposes the use of conventional, but specially selected, lithium ion insertion compounds (eg., intercalation oxides, sulfides, selenides, etc.) that can be coupled to allow desorbing and absorbing of lithium ions through the medium of an electrolysis resistant aqueous electrolyte solution. The electrochemical couple and the aqueous electrolyte system are carefully chosen from a variety of common, known materials/chemicals to produce a low cost, high specific capacity cell with a very precise voltage range (i.e., within a practical range of charge and discharge voltage whereby nearly full utilization of electrode capacity is achieved without degradation or other deleterious side reactions). In particular, the voltage must be higher than the electrolysis point of water (˜1.2 volt), in order to provide increased cell energy, but must be stable enough at the specified higher voltage level to provide stable self life on open circuit and efficient recharge without uncontrolled electrolysis of water (i.e., not likely exceeding 2.5 to 3.0 volt). Prior art selections reference the use of electrochemical couples for aqueous lithium cells either at or below 1.2 volt or at levels of 2.5 to 3 volts or higher. The former cells suffer from low cell energy and the later cells are impractical due to decomposition of the specified conventional aqueous electrolyte at the higher charge voltages. Additionally, no special aqueous electrolyte systems, possessing an increased level of electrolysis tolerance, are specified in the prior art, either. But also, the present invention recognizes the benefit of using enhanced recharge mechanisms to control the electrolysis of water at whatever charge voltage levels are used. Either the use of chemical additives (i.e., shuttle mechanisms) or physical designs (i.e., improved gas recombination pathways) are proposed to better regulate the electrolysis of water at charge voltage levels at or above 1.2 volts (the nominal electrolysis voltage point for pure water). The electrode active materials, electrolyte salts/ionic compounds, co-solvents (organic liquids, acids, bases, inorganic liquids, ionic liquids, etc.) and inert cell components (current collectors, electrode binders, separators) are all chosen to be compatible within the required voltage window of electrochemical cell operation.

While the concept of an aqueous lithium ion cell has been proposed previously, the prior inventions failed to overcome the problem of low voltage and low energy inherent with conventional aqueous electrolytes. While Beard, the present author of this patent application, actually first detailed the basic concept of an aqueous lithium ion cell about 20 years ago, the concept never proved viable as Beard at the time was unable to specify an aqueous electrolyte system with sufficiently high electrolysis potential. Beard realized that a high energy cell would not be practical because of the limited voltage capability of water, but was unable to identify any alternative aqueous systems with increased voltage stability. The cell would be less than 1.5 volts and hence not a very high capacity.

Beard's prior two patents with pertinent sections claiming an aqueous lithium ion cell are as follows,
1. U.S. Pat. No. 5,147,739: Table I, Item VIII.
2. U.S. Pat. No. 5,284,721: Tables I, Item VIII and Table II, Item VIII and claims 3-5.

Note that in '721, (Table II, VIII.) the cell is listed as having a 2.5 to 3 volt potential. This is impossible for a standard aqueous electrolyte of the type listed in the patent.

Only recently, it was identified that if an aqueous electrolyte with improved resistance to electrolysis is used, a high voltage, high energy cell could indeed be realized. Specifically, sulfuric acid, as used in all common lead-acid batteries, was first identified as having a voltage capability of ˜2.4 volts for use in aqueous lithium ion cell. The active lithium electrode and salt compounds must also then be selected to be stable in concentrated sulfuric acid.

However, an article from Korean researchers, investigating high voltage aqueous electrolytes for use in implanted biomechanical actuators (i.e., artificial muscles), identified various electrolysis-resistant aqueous electrolyte solutions that could be useful in a high voltage, high energy electrochemical energy storage device and would be quite benign in a lithium ion cell as follows,
“Electrolytic Stability of Various Inner Solutions in an Ionic Polymer Metal Composite”, Journal of the Korean Physical Society, Vol. 48, No. 6, June 2006, pp. 1594-1600 Jang-Woo Lee, Khanh Nguyen Vinh, Se-Young Park and Young-Tai Yoo, Artificial Muscle Research Center, Department of Materials Chemistry and Engineering, College of Engineering, Konkuk University, Seoul 143-701 (Received 20 Nov. 2005)

These high voltage aqueous electrolyte systems have already been proven for use in muscle stimulators at levels up to about 2.5 volts, but the technology was not identified for use in a battery, capacitor or fuel cell using these or similar electrolytes. It is not obvious to substitute the artificial muscle component parts with electrochemically active electrodes, then to incorporate appropriate separators and finally add functional lithium salts to yield an energy storage device. To be successful, one needs to find the right combination of anode, cathode and salts to go with the electrolyte solvents to make a useful, practical, functioning cell with voltage capabilities greater than 1.2 volts.

It takes very different aqueous electrolytes such as sulfuric acid, H₂O with DMSO (an organic liquid additive) or heavy water (D₂O) to be stable at >1.5 volts. Recent work with an H₂O/DMSO electrolyte system in a lithium ion cell has indeed demonstrated higher voltage capabilities (>2V).

What is claimed is:

1. An aqueous solvent electrolyte solution of high galvanic stability, within an electrochemical cell, comprising dissociable ionic species that are transported through said aqueous solvent between electrodes wherein said aqueous solvent possesses high electrolysis potential as well as high ionic conductivity and wherein the electrochemical reactions produce a thermodynamically elevated energy state sufficient to yield an energy storage and production device.

2. The electrolyte solution as in claim 1, further comprising one or more solvents of high galvanic stability selected from the group consisting of acids and bases and aqueous species based on protons or hydroxides as well as related hydrogen isotopes such as deuterium and tritium.

3. The electrolyte solution as in claim 1, further comprising one or more co-solvents selected from the group consisting of organic liquids, inorganic liquids and ionic liquids

4. The electrolyte solution as in claim 1, further comprising a gel polymer, a conductive solid, including solid state conductors or ionic conductive polymers.

5. The electrolyte solution as in claim 1, further comprising one or more ionic species selected from the group consisting of lithium, sodium, potassium, calcium and magnesium salts and hydroxides.

6. The electrolyte solution co-solvent as in claim 2, further comprising dimethylsulfoxide, deuterated dimethylsulfoxide and methyl cellosolve.

7. An electrochemical energy storage and production device using an aqueous electrolyte solvent of high electrolysis resistance and high galvanic stability.

8. The electrochemical energy storage and production device of claim 7, further comprising a cell with greater than 1.5 volt upper operating potential or preferably greater than 2.0 volts.

9. The electrochemical energy storage and production device as in claim 7, further comprising oxygen recombination.

10. The electrochemical energy storage and production device as in claim 7, further comprising an electrochemical cell or battery.

11. The electrochemical energy storage and production device as in claim 7, further comprising a capacitor.

12. The electrochemical energy storage and production device as in claim 7, further comprising a semi-fuel cell or fuel cell.

13. The electrochemical energy storage and production device as in claim 7, further comprising one or more solvents of high galvanic stability selected from the group consisting of acids and bases and aqueous species based on protons or hydroxides as well as related hydrogen isotopes such as deuterium and tritium.

14. The electrochemical energy storage and production device as in claim 7, further comprising one or more co-solvents selected from the group consisting of organic liquids, inorganic liquids and ionic liquids

15. The electrochemical energy storage and production device as in claim 7, further comprising a gel polymer, a conductive solid, including solid state conductors or ionic conductive polymers.

16. The electrochemical energy storage and production device as in claim 7, further comprising one or more ionic species selected from the group consisting of lithium, sodium, potassium, calcium and magnesium salts and hydroxides.

17. The electrochemical energy storage and production device as in claim 13, further comprising dimethylsulfoxide, deuterated dimethylsulfoxide and methyl cellosolve.
